(19) United States
(12) Patent Application Publication
(10) Pub. No.: US 2004/0215415 A1
(43) Pub. Date: Oct. 28, 2004

(54) Access-protected programmable instrument system responsive to an instrument-pass

(76) Inventors: Donald D. McIntosh, Milford, CT (US); David L. Sherman, Gilford, CT (US); Tyler J. Bessette, Milford, CT (US); David M. McCuen, Stratford, CT (US); Decker A. Cammack, Dallas, TX (US)

Correspondence Address: FISH & RICHARDSON P.C., 5000 BANK ONE CENTER, 1717 MAIN STREET, DALLAS, TX, 75201, US

(21) Appl. No.: 10/777,303

(22) Filed: Feb. 12, 2004

Related U.S. Application Data
(60) Provisional application No. 60/448,204, filed on Feb. 18, 2003.

(51) Int. Cl. G06F 19/00

(52) U.S. Cl. 702/127

(57) ABSTRACT

An electronic gauge system having an access module to restrict access to at least one programmable feature of the gauge. The access module is responsive to an instrument-pass to allow and to restrict access to at least one of the programmable features of the gauge. The gauge system may be coupled to a transmitter that allows the gauge to communicate with a central control system.

This application claims the benefit of U.S. Provisional Application No. 60/448,204 filed Feb. 18, 2003, the contents of which is incorporated herein by reference.

### FIELD OF THE INVENTION

Electronic instruments, and in particular, programmable instruments.

### BACKGROUND OF THE INVENTION

Many digital instruments, such as gauges, include programmable parameters or features that may be modified by the user. To eliminate inadvertent modifications and intentional tampering with and protect these programmable features, access to these features needs to be restricted to authorized individuals. Previous attempts to provide this needed protection have included the use of a cumbersome system of lock-boxes enclosing every instrument and a plurality of mechanical keys providing access to the lock-boxes. In addition to being cumbersome, this mechanical system is costly to implement and to modify in the event keys are lost. Other attempts at protecting the programmable features have involved the use of a numerical passcode system that will allow access to the protected features by entering the passcode on a numerical keypad connected to the instrument. While this numerical passcode system is effective, some customers and regulatory agencies are not satisfied with the level of security provided, as the code can be shared verbally with many people without clear control. And in general, there is an increasing need to provide better security.

### SUMMARY OF THE INVENTION

The invention provides increased security in a cost effective manner through use of a system comprising a discrete instrument-pass or “key” for each instrument that is to be protected from unauthorized tampering. This key provides user access to the instrument's protected programmable features. The invention can be an option on existing digital instruments, allowing users to change certain protected features, such as the ability to reset zero, delete functions, or recalibrate the instrument.

Various aspects and implementations of the present invention provide various advantages over the prior art. For example, a method for operating the instrument-pass system allows increased functionality for an instrument using features of the present invention. Yet another advantage includes a centralized control mechanism for maintaining access logs, access codes, and/or authorization lists. In another aspect of the invention, an instrument includes, or is coupled to a transmitter that allows the instrument to communicate with a central control system. The key allows a user to access the instrument based on the proximity of the key and an access module collocated with the instrument. And yet another aspect of the invention, a method includes introducing a key to the instrument, and accessing the instrument to manipulate the instrument's settings. This aspect may include entering a passcode to further allow access to the instrument.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

In the drawings:

FIG. 1 illustrates an access-protected instrument comprising an instrument and an instrument-pass.

FIG. 2 illustrates an access-protected instrument of FIG. 1 communicable with a network.

FIG. 3 is a flow chart illustrating a method for accessing an access-protected instrument of FIG. 1.

FIG. 4 illustrates a logic system for maintaining an access-protected instrument of FIG. 1

### DETAILED DESCRIPTION OF THE ILLUSTRATED EMBODIMENT

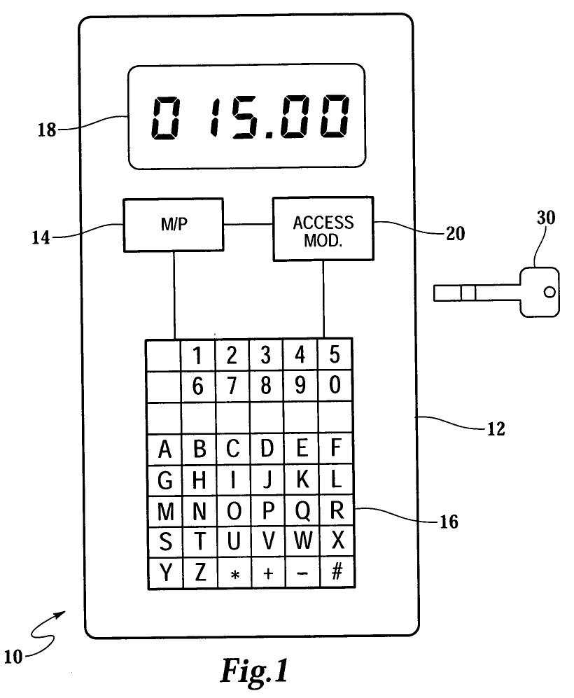

Described in more detail hereinafter is an electronic instrument having an access module to restrict access to at least one programmable feature of the instrument. The access module is responsive to an instrument-pass. For the purposes of this application, the term “instrument” includes, but is not limited to, any type of diagnostic or maintenance equipment or device, such as a gauge. For simplicity, the term “gauge” is understood to refer to programmable instruments. Referring now to the drawings wherein like reference characters denote like or similar parts throughout the Figures, FIG. 1 illustrates an access-protected gauge system 10. The access-protected gauge system 10 includes an electronic diagnostic gauge 12 having a microprocessor 14 with at least one programmable feature stored therein and a keypad 16 coupled to the microprocessor 14 for programming the programmable features. The diagnostic gauge may be, for example, a pressure gauge having the capability to measure pressure, or a temperature gauge or other diagnostic gauge. The gauge 12 comprises a display 18 to display measurement data and other information. Secured access is provided through an access module 20 that is responsive to an instrument-pass 30 when the instrument-pass 30 is brought within a predetermined proximity of the access module 20. In one implementation, the user would bring the instrument-pass 30 into close proximity to or actual contact with the gauge to gain access. Instrument-pass 30 may also have a mechanical connection-such as inserting a key into a lock—with the access module 20. The instrument-pass 30 is illustrated and may be referred to herein as a “key”. However, the instrument-pass 30 may assume any configuration and is not limited to the configuration of a key illustrated herein.

A discrete key, or instrument-pass 30, for each gauge 12 or a group of gauges provides the user access to at least one protected programmable feature of a gauge 12, such as the ability to reset zero, delete features, or recalibrate the gauge. The aforementioned protected programmable features are illustrative and not limiting. The gauge 12, being responsive to the proximity of the instrument-pass 30, allows the protected features to be modified. In one embodiment, the access module 20 enables and disables the keypad 16 in response to the proximity of the instrument-pass 30. In another embodiment, access to modify selected programmable features is allowed and restricted in response to the proximity of the instrument-pass 30.

The electronic access may be based on at least one of several different technologies, such as a radio frequency transponder (RFID), infrared, bar code, magnetic strip, decoding electronic device, or a self-contained electronic circuit, whether now known or hereafter developed. Additionally, the instrument-pass may simply be a resistor, which when brought within the predetermined proximity of the access module, has a value that can be read and a corresponding level of access allowed based on the value. Similarly, the instrument-pass 30, depending on the particular application, may be a key ring pendant, plastic “wedge” or disk, proximity card or “smartcard”, infrared module, magnetic strip card, barcode card or a traditional key.

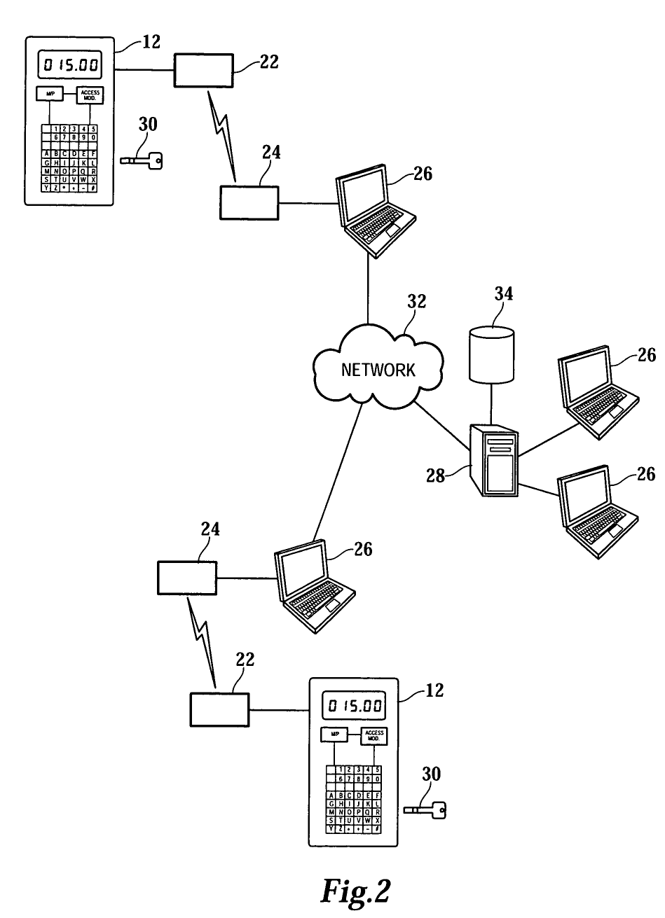

FIG. 2 illustrates a diagnostic gauge 12 coupled to a transmitter 22. Referring to FIGS. 1 & 2, upon access by a key 30, microprocessor 14 of gauge 12 may direct remote transceiver 22 to communicate with a base transceiver 24 coupled to a workstation 26. Remote transceiver 22 and base transceiver 24 may incorporate transmission technologies such as RFID, analog wireless transmission, packet-based or digital wireless transmission such as asynchronous transfer mode (ATM), optical, wireline, web-based (such as Web services communications) or other transmission technology that enables one or more remote transceivers 22 to communicate with one or more base transceivers 24.

Workstation 26 may be a personal computer, computer workstation coupled to a larger network 32, individual database log, or other device capable of processing information to gauge 12. Additionally, workstation 26 may include any combination of input/output devices, memory storage, microprocessors, local storage, or other devices. Workstation 26 may also be coupled to network 32, which may be a local area network (LAN), wide area network (WAN), metropolitan area network (MAN), optical network, wireless network, portions of the Internet, or any other network capable of transmitting data from one work station to another.

Network 32 may be coupled to a server or servers 28, which may include workstations 26 coupled to server 28, and may also include a database, or storage apparatus 34. Workstation 26 may include local storage, random access memory (RAM), read only memory (ROM), a microprocessor, logic unit, or other type of processing device, a display, and/or input/output devices. Workstation 26 may also include an access module 20 adapted to communicate with an instrument-pass 30.

In one implementation of the invention, digital gauge 12 is accessed by a user. The user accesses digital gauge 12 by bringing instrument-pass 30 into a predetermined proximity of access module 20 (illustrated in FIG. 1). The predetermined proximity required for instrument-pass 30 to access module 20 may be any predetermined distance, and may additionally include inserting the key into a portion of digital gauge 12 that is connected by wire line, optical, radio frequency, or other self-contained electronic circuit to access module 20. Access module 20 may be operable to access remote transceiver 22 directly, or may relay the access information gained by access module 20 through the introduction of instrument-pass 30 to microprocessor 14. Microprocessor 14 may then direct remote transceiver 22 to transmit access information to a base transceiver 24 coupled to work station 26.

Workstation 26 may store access information received via base transceiver 24 locally, or may transmit the information to a server 28 or another workstation 26 via network 32 for storage at a different location. Alternatively, a plurality of digital gauges 12 coupled to remote transceivers 22 may be operable to transmit access data to work stations 26 located at other sites, or at different locations within the same site. When transmitting access data to a server 28, the server 28 may store the access data in internal memory storage, such as ROM, RAM, writable storage media, or other internal storage device, or server 28 may direct a database 34 to store access information categorized by any of a number of criteria for future reference.

The types of access data that may be transmitted by a gauge 12 to a work station 26 and/or other storage devices coupled to network 32 may include instrument-pass identification, instrument-pass user information, settings prior to access by the instrument-pass, settings changed as a result of the user accessing the digital gauge with the instrument-pass 30, date, time, or any other identifiers which may allow for categorization, retrieval, maintenance, and other necessary functions.

In an alternative implementation, a user may bring an instrument-pass 30 into the predetermined proximity of an access module 20 coupled to workstation 26. If the programmed parameter in the instrument-pass 30 corresponds to the access requirements for a predetermined access level, the user obtains a validated entry. Upon validating the use-level associated with instrument-pass 30, the access module 20 may allow the user to remotely access any one digital gauge 12 or multiple digital gauges 12 remote to workstation 26. For example a master instrument-pass 30 may allow the user to access every digital gauge 12 coupled to workstation 26 corresponding to the access level of the instrument-pass 30 used. “Coupled”, in reference to the number of digital gauges, may include any digital gauge 12 located within transmission proximity of workstation 26 via base transceiver 24 and remote transceivers 22. Alternatively, “coupled” may include any digital gauge 12 communicable with the accessed workstation 26 via network 32.

Additional implementations may require the user to input a code or identification into keypad 16 of digital gauge 12 after the user has been granted access via access module 20. For example, a user attempting to access a digital gauge by an instrument-pass 30 may bring the instrument-pass into the pre-determined proximity of access module 20. In this implementation, access granted by access module 20 may include merely directing or allowing microprocessor 14 to “unlock” or grant access to keypad 16. The user may then be required to enter a personal identification number (PIN), user identification, passcode, or other information via keypad 16. After the user has entered the PIN or other required information, the microprocessor 14 may grant access to the user associated with the instrument-pass 30 used to access the digital gauge 12.

Another implementation may allow a user to access the digital gauge 12 by accessing an access module 20 coupled to a workstation 26. Workstation 26 may then require the user to input the user's PIN, user identification, passcode or other information via an input/output device that is part of Workstation 26, as described above.

FIG. 3 illustrates a method for operating an instrument-pass system 300. At step 310, an instrument-pass is introduced to a digital gauge. The introduction of an instrument-pass to a digital gauge may include bringing the instrument-pass into a predetermined proximity of the digital gauge, or touching the digital gauge. Alternatively, the predetermined proximity may include inserting the instrument-pass into a receptacle located on the digital gauge, such as a key slot, keyhole, card slot, or other receptacle designed to accept the instrument-pass. At step 320, a passcode may be required to permit further access, or a specific level of access to the digital gauge accessed by the instrument-pass. If, at step 320 a passcode is required, the user enters the passcode at step 322. If no passcode is required, then at step 330, additional instrument-passes may be required to permit further access to the gauge. If at step 330 additional instrument-passes are required, then the process returns to step 310 in which a key must be introduced. If at step 330 no additional key is required, at step 340, access to the gauge is granted and a user may manipulate the gauge up to the level of access authorized by the access key.

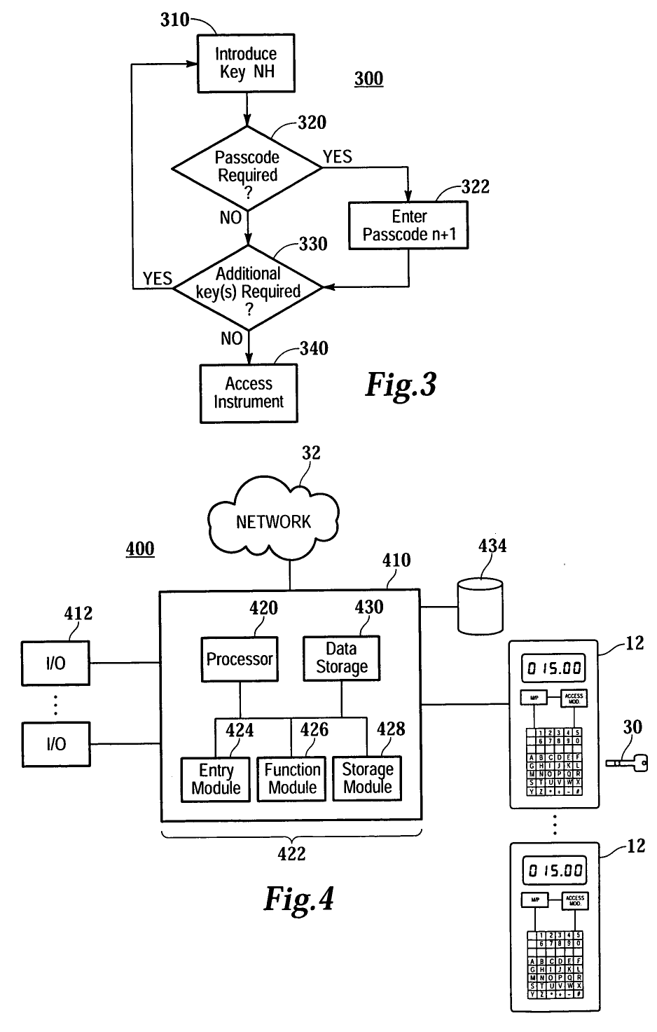

Referring to FIG. 4, a logic system for an instrument-pass system 400 includes a management system 410. Management system 410 may be a computer workstation (such as a workstation 26 described above and illustrated in FIG. 2), server, discrete computing device, or other system operable to employ various modules for controlling, regulating, or otherwise maintaining an instrument-pass system. Management system 410 may be coupled to, or resident within, one or more digital gauges 12 and/or network 32, and may include one or multiple input/output devices 412, one or more processors 420, one or more data storage devices 430, and one or more modules 422.

Input/output devices 412 may comprise a computer monitor, keyboard, mouse, voice recognition device, touch screen, compact disk drive (CDROM), floppy disk drive, or other suitable input/output device, such as a transceiver 22 or 24 as illustrated in FIG. 2. Additionally, input/output devices 412 may be a workstation 26 illustrated in FIG. 2 having all the functionality described therewith. Processor 420 may include a microprocessor with resident memory such as Read Only Memory (ROM), Random Access Memory (RAM), programmable gate arrays, or other suitable processing technology. Additionally, management system 410 may include an internal data storage unit 430 such as a hard drive with writable media, recordable CDROM (CD-R), re-writable CDROM (CD-RW), and/or an external storage unit 432 such as a database.

Modules 422 may provide specific functionality to management system 410 associated with pre-programmed functions of each module. For example, modules 422 may provide specific functionality such as allowing entry into the system, defining the scope of any access granted by the system, and directing the storage and retrieval of information transmitted or received by management system 410.

Modules 422 illustrated by FIG. 4 include an entry module 424, a function module 426, and a storage module 428. Each of the modules 422 may be either programmed into the resident memory of processor 420 or may be resident in an input/output device 412 coupled to management system 410 and communicable with processor 420. Entry module 424 may protect access to management system 410, to one or more digital gauges 12, or to management system 410 and digital gauges 12. Entry module 424 may be programmed with access levels associated to various instrument-passes communicable with management system 410.

Function module 426 may provide functionality associated with manipulating digital gauges 12. Function module 426 may allow a user to access records for various digital gauges 12 to determine past programming activities such as the date, time, and nature of any past programming activities. Additionally, function module 426 may allow a user to manipulate digital gauges 12 remotely via an input/output device 412 coupled to management system 410.

Storage module 428 may provide functionality associated with storing the passcodes, PINs, user identifications, access levels, or other data associated with instrument-passes 30. Additionally, storage module 428 may be operable to store a log or database listing corresponding to each instrument-pass 30, the digital gauge or gauges 12 accessed, and the actions performed with respect to the digital gauges 12 accessed.

In operation, management system 410 may receive an access transmission via a transceiver or local user use of an instrument-pass 30. Upon receiving the transmission, processor 420 may access one or more of modules 422 to employ the necessary functionality programmed into one or more of the modules 422. For example, in one implementation, entry module 424 may call on data storage module 428 to determine whether the instrument-pass 30 used to access the system is appropriate for a digital gauge 12 managed by management system 410. Additionally or alternatively, entry module 424 may verify the access level associated with the instrument-pass 30 used to access the system.

If entry module 424 is programmed to require additional access, such as a user PIN or identification, entry module 424 may direct processor 420 to communicate the requirement to a user via an input/output device 412, or if the user is attempting to access the gauge 12 at the gauge location, then by transmitting a message to the gauge 12 via a base transceiver 24 to a remote transceiver 22. If the user is attempting to gain gauge access at the digital gauge 12, then management system 410 may provide a prompt on display 18 of gauge 12 (see FIG. 1). If the user attempts to access a digital gauge or gauges 12 from a workstation 26, then entry module 424 could direct processor 420 or other suitable element of management system 410 to provide a prompt at the workstation 26 accessed by the user, or other suitable input/output device 412.

Once a user enters the required PIN, user identification, or passcode, processor 420 may call on function module 426 to provide the functionality desired by the user. Examples of functionality provided by function module 426 may include resetting a gauge or gauges 12, opening or closing valves controlled by a gauge 12, or inputting values for gauge 12 operation. Additionally, function module 426 may simultaneously employ the functionality of entry module 424 for each function performed by management system 410 or a user to ensure that the function performed is within the access level associated with the instrument-pass 30 used to gain access to the system 400. In this or another implementation, function module 426 may call on storage module 428 to record the actions of management system 410, functions performed by a user accessing management system 410, or the functions of gauge 12 altered or manipulated as a result of access granted by management system 410.

Storage module 428 may control data storage in data storage 430 or in external data storage such as database 432. In an implementation, processor 420 may monitor the functions of management system 420 and direct storage module 428 to store or update storage information in data storage 430 or database 432. Examples of data that may be stored by storage module 428 are date and time of access, level of access, the identification of the instrument-pass 30 used to gain access, functions accessed by management system 410, and/or actions performed on gauge 12. Additionally, storage module 428 may be operable to recall stored information when requested by processor 410 as a result of input from an input/output device 420 or by a preprogrammed element of function module 426 or storage module 428, such as a random report or a periodic report.

As described above, electronic instrument-pass technology may provide better control over gauge access than the passcode or lock-box approaches currently in use. An instrument-pass system is also much easier to implement than installing mechanical lock-boxes around each gauge.

In alternate implementations of the instrument-pass system, gauges may be programmed to accept multiple levels of keys, such that one key is provided for every gauge in a room of a plant, a master key is provided for every gauge in that building, and a grand master is provided for every gauge in the customer's plant.

Although preferred and alternate embodiments of the present invention have been disclosed in the foregoing Detailed Description, it will be understood that the invention is not limited to the implementations disclosed, but is capable of numerous rearrangements, modifications, and substitutions without departing from the spirit of the invention.

What is claimed is:

1. A gauge system comprising:
an electronic instrument including at least one programmable feature and at least one access module restricting access to the at least one programmable feature; and
an instrument-pass operable with the access module, wherein the access module is responsive to the instrument-pass to allow and to restrict access to the at least one programmable feature.

2. The system of claim 1, wherein the access module and the instrument-pass comprises a radio frequency identification device system.

3. The system of claim 1, wherein the access module comprises a radio frequency transponder.

4. The system of claim 1, wherein the access module comprises an infrared detector and the instrument-pass is an infrared transmitter.

5. The system of claim 1, wherein the access module comprises a reader selected from the group consisting of a bar code reader and a magnetic strip reader.

6. The system of claim 1, wherein the access module includes a physical device connection, and wherein the instrument-pass includes an encapsulated electronic component to activate the access module.

7. The system of claim 6, wherein the encapsulated electronic component is a resistor.

8. The system of claim 1, further comprising:
a first transceiver coupled to the electronic gauge;
a workstation; and
a second transceiver coupled to the workstation, wherein the first transceiver is operable to transmit to the second transceiver the access to the at least one programmable feature.

9. The system of claim 8, wherein the first and second transceivers communicate using digital communication technology.

10. The system of claim 9, wherein the digital communication technology is packet-based communication.

11. The system of claim 10, wherein the digital communication technology is asynchronous transfer mode.

12. The system of claim 8, wherein the first and second transceivers communicate using analog communication technology.

13. The system of claim 8, wherein the first and second transceivers communicate using radio frequency transponders.

14. The system of claim 8, wherein the first and second transceivers communicate via a wireline link.

15. The system of claim 8, wherein the first and second transceivers communicate via an optical link.

16. The system of claim 8, wherein the workstation is operable to receive information from the electronic gauge via the first and second transceivers.

17. The system of claim 8, wherein the workstation is operable to transmit information to the electronic gauge via the first and second transceivers.

18. The system of claim 8, further comprising a network, wherein the workstation is coupled to the network, the workstation operable to transmit and receive information via the network.

19. The system of claim 18, wherein the network comprises a local area network.

20. The system of claim 18, wherein the network comprises a wide area network.

21. The system of claim 18, wherein the network comprises a portion of the Internet.

22. The system of claim 18, wherein the network comprises an optical network.

23. The system of claim 18, further comprising a server, wherein the server is operable to transmit and receive information from the workstation.

24. The system of claim 8, further comprising a workstation access module operable with the instrument-pass key, wherein the workstation access module provides access to the programmable features of the electronic gauge.

25. A method of providing security for a gauge comprising:
detecting the presence of an instrument-pass; and
if the instrument-pass satisfies predetermined access criteria, allowing access to at least one programmable feature of the gauge.

26. The method of claim 25, further comprising the step of entering a code to allow access to the at least one programmable feature of the gauge.

27. The method of claim 26, wherein the step of entering the code is performed before the instrument-pass can be detected.

28. The method of claim 26, wherein the step of detecting the instrument-pass is performed before the step of entering the code.

29. The method of claim 25, wherein the instrument-pass is detected at the gauge.

30. The method of claim 25, further comprising transmitting the presence of the instrument-pass to a remote transceiver.

31. The method of claim 30, further comprising detecting the transmitted presence of the instrument-pass by a workstation coupled to the remote transceiver.

32. The method of claim 31, further comprising allowing access to the at least one programmable feature of the gauge from the workstation.

33. The method of claim 25, wherein the instrument-pass is detected at a workstation remote from the gauge.

34. The method of claim 33, wherein detecting the instrument-pass allows access to the at least one programmable feature of the gauge from the workstation.

35. A method of providing security for a gauge comprising:
reading information from an instrument-pass;
determining if the read information satisfies predetermined access criteria; and
selectively allowing and denying access to at least one programmable feature of the gauge based on the determination of whether the read information satisfies predetermined access criteria.

36. The method of claim 35, further comprising:
determining if the read information requires additional input;
prompting for the additional input; and
reading the additional input, wherein reading the additional input selectively allows and denies access to the at least one programmable feature of the gauge based on the determination that the additional input satisfies predetermined access criteria.

37. The method of claim 36, wherein the additional input is a personal identification number.

38. The method of claim 35, wherein reading information from an instrument-pass comprises accessing programmed material stored in the instrument-pass, the programmed material corresponding to a predetermined access level.

39. The method of claim 38, wherein the determination of whether the read information satisfies the predetermined access criteria comprises comparing the access level of the programmed material with the predetermined access criteria.

40. A gauge system comprising:
an electronic diagnostic gauge including access module for restricting access to the electronic gauge;
a first instrument-pass, wherein the access module is responsive to the first instrument-pass to allow a first level of access to the electronic gauge; and
a second instrument-pass, wherein the access module is responsive to the second instrument-pass to allow a second level of access to the electronic gauge.

41. A gauge system comprising:
an instrument-pass including access information; and
an electronic instrument including an access module responsive to the instrument-pass to allow or deny access to at least one programmable feature of the gauge based on the access information.

42. The system of claim 41, wherein the access information comprises a predetermined radio frequency.

43. The system of claim 41, wherein the access module comprises a reader.

44. The system of claim 41, wherein the access module comprises a detector.

45. A gauge management system comprising:
an instrument-pass;
an entry module operable to control access to an instrument;
an input/output device; and
a function module operable to manipulate programmable features of the instrument, wherein the entry module allows access to the gauge upon receiving a predefined access criteria from the instrument-pass, and wherein the function module manipulates the programmable features of the instrument based on input from the input/output device.

46. The system of claim 45, further comprising a storage module operable to store access information in a database.

47. The system of claim 46, wherein the storage module is further operable to retrieve information from the database.

48. The system of claim 45, wherein the entry module and function module are programmed into the gauge.

49. The system of claim 45, further comprising a workstation, wherein the entry module and function module are programmed into the workstation, the workstation coupled to the gauge and adaptable to receive the predefined access criteria from the instrument-pass.

50. The system of claim 49, further comprising:
a first transceiver coupled to the gauge; and
a second transceiver coupled to the workstation, wherein the first and second transceivers are operable to communicate the access criteria and the input of the input/output device between the gauge and the workstation.
